(19) United States
(12) Patent Application Publication
(10) Pub. No.: US 2008/0010301 A1
(43) Pub. Date: Jan. 10, 2008

(54) Method and system for notifying presence information

(75) Inventors: Linyi Tian, Shenzhen (CN); Quan Zhang, Shenzhen (CN); Yahng Zhao, Shenzhen (CN); Qian Sun, Shenzhen (CN)

Correspondence Address: Robert Popa;c/o LADAS & PARRY LLP, Suite 2100, 5670 Wilshire Boulevard, Los Angeles, CA, 90036-5679, US

(73) Assignee: HUAWEI TECHNOLOGIES CO., LTD

(21) Appl. No.: 11/881,183

(22) Filed: Jul. 25, 2007

Related U.S. Application Data
(63) Continuation of application No. PCT/CN06/02370, filed on Sep. 13, 2006.

(30) Foreign Application Priority Data
Nov. 4, 2004 (CN) 200510115511.9

(51) Int. Cl. G06F 17/30

(52) U.S. Cl. 707/10

(57) ABSTRACT

A method for notifying presence information is disclosed. The method includes: setting, by a presentity, notification rules; when receiving the presence information sent from a presentity client or presentity application server, transferring, by a presence server, to a watcher client or watcher application server the presence information that is conformable to the notification rules as well as content related processing rules set by a watcher and the presentity. The present invention further discloses a system for notifying presence information, a presence server and a presence XDMS. Compared with the prior art, the present invention takes advantages of resources of a presence server more appropriately and enables the publication of presence information to be more rationalized and humanized. Thus a user may determine whether to receive the published information and what published information to receive according to the actual requirement.

### FIELD OF THE INVENTION

The present invention relates to a method and a system for notifying information, and more particularly to a method and a system for notifying presence information.

### BACKGROUND OF THE INVENTION

At present, the presence service is in increasingly wide use. The presence service is a communication service that collects and issues presence information. Many people want to obtain presence information of a user of presence service, including the family and friends of the user, or even a stranger. However, much of the presence information may be the user's privacy. The presence service enables the user to utilize various terminals to look for a chat pal, to inquiry about the status information of the chat pal or the like beyond the restriction of space and time, so as to achieve an instant text and multimedia information exchange. A presence server is capable of presenting and managing the status of users. A user may know from the presence information whether the opposite party is online, what he is engaged with (e.g. a meeting, a dinner, etc.), his mood, client capability, hobbies or other information. The user may send invitations to other users to share media contents, such as a ring, a picture, a file, etc.

FIG. 1 illustrates a structure of a system for notifying presence information in the prior art. The system includes a presentity client or presentity application server, a presence server, a watcher client or watcher application server, and a presence XDMS (XML Document Management System). A presentity is a logical entity that has Presence Information associated with it. This Presence Information may be composed of a multitude of Presence Sources. A presentity is most commonly a reference for a person, although it may represent a role such as “help desk” or a resource such as “conference room #27”. The presentity is identified by a SIP URI (as defined in [RFC3261]), and may additionally be identified by a pres URI (as defined in [RFC3859]). A watcher is any uniquely identifiable entity that requests presence information about a presentity, from the presence service.

The presentity client or presentity application server is the source of presence information. When its presence information changes, the presentity client or presentity application server sends a PUBLISH message initiatively to the presence server, to publish the presence information.

The watcher client or watcher application server sends to the presence server a SUBSCRIBE message subscribing for the presence information from the presentity, and receives NOTIFY messages from the presence server.

The presence XDMS (XML Document Management System) stores authorization rules of the presentity (e.g. subscription authorization rules, content authorization rules, etc.), etc.

The presence server is the core of the system. It is capable of presenting and managing the status of users. It includes a subscription processing component, a storage component and a publication and notification processing component.

After receiving the SUBSCRIBE message from the watcher client or watcher application server, the subscription processing component obtains subscription authorization rules set in the presence XDMS by the corresponding presentity, determines the result of the subscription in accordance with the subscription authorization rules, and if the subscription is allowed, saves the subscription relationship in the storage component.

The storage component stores information including the subscription authorization rules, the subscription relationship, published content, etc.

After receiving a publish request sent from the presentity client or presentity application server, the publication and notification processing component retrieves a certain subscriber (a watcher) from the storage component and relevant rules set by the presentity and the watcher, processes the presence information in accordance with the relevant rules, and notifies the watcher client or watcher application server of the processed (composed, transformed, content-filtered, etc.) presence information.

The publication and notification processing component is the most important component in the presence server. Its structure is as illustrated in FIG. 2. The publication and notification processing component further includes a presence information composition unit, a content authorization rules checking unit, a watcher filtering unit, a partial notification processing unit, and a presence information publication unit, all of which are connected sequentially.

The presence information composition unit is adapted to receive published information sent from the presentity client or presentity application server, and compose the presence information which is newly published with the presence information stored in the presence server.

The content authorization rules checking unit is adapted to filter off the information which is not allowed for publication in accordance with the rules set by the presentity client or presentity application server (e.g., rules that specify what information is allowed for publication with respect to a certain watcher client or a watcher application server).

The watcher filtering unit is adapted to filter off undesired presence information content (e.g., the watcher requires only the presence information related to the status of the user, other presence information will be filtered off) in accordance with an Event Notification Filtering rules set by the watcher (e.g., rules that specify which information of a certain presentity client or presentity application server is undesired).

The partial notification processing unit is adapted to filter off the information that is not subscribed in accordance with the rules set by the watcher client or presentity application server upon subscription (e.g., only subset of presence information relevant to the position of the user is subscribed).

The presence information publication unit is adapted to notify the watcher client or watcher application server of the processed presence information.

The above rules used by the publication and notification processing component are existing rules. The content authorization rules checking unit, the watcher filtering unit and the partial notification processing unit are all optional, and the connection sequence between them may be altered arbitrarily. If the presentity or the watcher hasn't set certain rules, the corresponding unit(s) may be omitted. Furthermore, the above rules in the prior art are all content related processing rules.

In the above system, the presentity application server and the watcher application server may be configured as one application server or may be configured separately as required.

The watcher client or watcher application server and the presentity client or presentity application server may be a SIP (Session Initiation Protocol) capable mobile terminal, such as a mobile phone, a PDA (Personal Digital Assistant), an intelligent terminal (e.g., a digital set-top box) or the like, or may be a fixed terminal capable of SIP. An application for presence information subscription is provided on the watcher client or watcher application server. A user may use this application to select information to be subscribed. After the information to be subscribed is determined, the watcher client or watcher application server may send such information to the presentity server along with the identity of the user.

According to the above solution, SUBSCRIBE and PUBLISH are both SIP messages. The field “From” in the SIP head of SUBSCRIBE indicates the identity of the watcher, and the field “To” indicates the identity of the presentity. If the message body is empty, all the presence information will be subscribed, and if the message body contains a partial subscription XML document, that document will specify the information to be subscribed. The subscription authorization rules in the prior art is described with an XML document including elements such as <Condition>, <Action> and <Transformation>. The element <Condition> represents matching conditions, including 1) Identity: identity of user, e.g., “sip:zhangsan@163.com”; 2) Domain, e.g., “@163.com”; the presence information, such as the status of an activity (e.g., in a meeting, a dinner, etc.), may be published for the users who match the condition <Condition> after they have subscribed successfully. The element <Action> represents an action to be performed when matched, including Allow, Block, Polite-Block (which returns the information of successful subscription, but never notifies the watcher any presence information. In other words, this is a friendly refusal with the same effect as Block) and Confirm (wait for confirmation). The element <Transformation> represents which information is allowed to be published for a watcher when the watcher has subscribed successfully. This is effective only during the publication and is controlled by the presentity, and determines which present information elements are allowed for publication and which are not allowed in accordance with only the pre-configuration of the presentity for the presence information. As a result, it is difficult to achieve dynamic control. For example, it is difficult to allow the notification of presence information in accordance with the status of the watcher or the presentity.

In the prior art, there are two solutions for the determination of presence information, i.e. partial subscription and event notification filter. The partial subscription means to specify the scope of presence information to be subscribed upon subscription, such as which type(s) of presence information to be subscribed, which part(s) of this type(s) of presence information to be subscribed, etc. The event notification filter refers to some filtering set by the watcher for the contents of presence information. For example, only presence information elements in compliance with a certain namespace may be received, etc.

A subscription request includes two parts, i.e., a “message head” and a “message body”. Here, the “message head” indicates the information of the watcher, the presentity, etc., and the “message body” contains an event notification filtering rules indicating the subscription scope (whether to subscribe all or partial of information of a certain type) of presence information. The event notification filtering rules are optional.

In the above solutions, the presence XDMS is separated from the presence server, and various rules are stored in the presence XDMS. The XDMS settings are presented and various rules are modified by the presentity client by using the XCAP protocol via an Aggregation Proxy, or by the presentity application server by using the XCAP protocol directly, or by the user via a human-machine interaction interface (e.g., a webpage). In the prior art, the presence XDMS may also be integrated with the presence server, and thus, various rules may be stored in the presence server.

A method for notifying presence information in the prior art will be described in detail with reference to FIG. 3.

1) A presentity A first sets some content-related processing rules at a presence XDMS, such as subscription authorization rules (which users are allowed for subscription), content authorization rules (what information is allowed for publication), etc. A presence server may obtain these rules through the XCAP protocol. Alternatively, if the presence server has subscribed for the notification of any change in these rules, the presence XDMS will notify the presence server when any of these rules is changed. The subscription authorization rules and the content authorization rules are stored in an XML file. The XML file includes three important elements <Condition>, <Action> and <Transformation>. The <Condition> represents a matching condition, and the <Action> represents a matching result (Allow, Block, Polite-Block and Confirm). The combination of <Condition> and <Action> constitutes the subscription authorization rules, and are utilized to process a subscription request from the watcher in accordance with the rules set by the presentity. The <Transformation> constitutes the content authorization rules, and is utilized to filter off or adapt the information which is not allowed for publication in accordance with the rules (what information is allowed to be published for a certain watcher) set by the presentity. For example, <namespace> used in the event notification filter indicates that the presence information in compliance with this namespace is subscribed, and <include> used in <what> indicates the presence information field(s) to be subscribed (Only some of event notification filtering conditions are described here as examples).

2) A watcher B sends a SUBSCRIBE message to the presence server to subscribe the presence information of the presentity A.

3) The presence server receives the SUBSCRIBE message from the watcher B, and then retrieves from the presence XDMS the subscription authorization rules set by the presentity A, and determines the subscription result in accordance with the subscription authorization rules. If the subscription is allowed, this subscription relationship may be stored.

4) The presentity A sends a PUBLISH request to the presence server.

5) The presence server receives the PUBLISH request sent from the presentity A, gets a certain subscriber (the watcher B) according to subscription relationship, retrieves the content-related processing rules set by the presentity A and the watcher B, and then publish in accordance with the content-related processing rules.

The process of publishing the presence information by the presence server in accordance with the content-related processing rules upon receiving the PUBLISH request sent from the presentity A includes the following steps:

51) composing the presence information newly published and the presence information stored in the server;

52) filtering off the information disallowed for publication in accordance with rules set by the presentity (e.g., rules that specify the information which is allowed to be published for a certain watcher client);

53) filtering off the information beyond the scope of the subscription in accordance with rules set by the watcher upon subscription (e.g. rules that only the subset of the presence information related to the location of a user is subscribed); filtering off the undesired information in accordance with rules set by the watcher (e.g. a rule that specifies the undesired information from a certain presentity). For instance, the watcher desires only the presence information related to the status of a user, and other information will be filtered off;

54) notifying watcher B of the processed presence information.

The above prior art solution has a drawback that the presentity cannot set notification conditions. It may be desirable for the presence user to set some authorization rules to further control the subscription and publication rather than just the content of presence information. In addition to a blacklist and a white list (e.g., users A and B are allowed, and user C is disallowed), the authorization rules may further include the number of times that the presence information is allowed to be published, the number of times that the presence information is allowed to be subscribed, etc. The presence information from the user cannot be obtained after a condition relevant to the number of times is exceeded. In particular, users may be charged for subscription of presence information published by a nonhuman presentity, such as a radio program, weather broadcast, a stock market information, etc. It may be desirable for the nonhuman presentity to set a free trial number of times (e.g. 100 pieces for free) or a free trial period (e.g. 8:00˜18:00, each day of Aug. 1, 2005˜Sep. 1, 2005) for publishing the presence information, as well as a number of times that the presence information is allowed to be subscribed (e.g. three times). For instance, if a watcher subscribes the presence information for the first time, the watcher may receive the presence information for free within a predetermined number of times that the information is allowed to be published or subscribed. However, when the number of times has been exceeded, and the watcher has not established a subscription relationship with a charge plan, the provision of the presence information may be terminated or the subscription may be blocked automatically, while the watcher may be added to the blacklist.

In addition, the presentity may wish not to publish the presence information to the watcher during some periods of time, which, however, would be impracticable in the prior art. For example, a boss has subscribed the presence information on the location of an employee, while the employee may desire to publish the presence information to the boss only during the working hours (e.g., effective from 8:00 to 18:00).

Furthermore, the presentity may also wish not to publish the presence information to the watcher when the presentity is in a particular status, which is also impracticable in the prior art. For example, the boss has subscribed the presence information on the location and the status of an employee. When the presentity is playing a game, he may change his presence status to the status “In Game”, and may have set in advance that the presence information in such a way that his status “In Game” will not be transmitted to the boss. Therefore, although the presentity publishes the presence information to the presence server, the presence server will not send the presence information to the subscriber, i.e. the boss, in accordance with the setting of the presentity.

### SUMMARY OF THE INVENTION

The present invention provides a method and a system for notifying presence information, which may enable a presentity to set a publication period and a validity period for the presence information, a number of times that a subscriber may receive the information, a number of times that the subscriber may subscribe the information, and a presence server may determine whether to send notifications to a watcher in accordance with such conditions.

An embodiment of the present invention provides a method for notifying presence information which may include: transferring, by a presence server, to either one of a watcher client or watcher application server the presence information that is conformable to notification rules set by a presentity as well as content-related processing rules set by a watcher and the presentity, when receiving the presence information sent from either one of a presentity client or presentity application server.

Optionally, the notification rules may include: allowing presence information to be notified when notification time of the presence information is within a validity term and/or a prescribed publication period.

Optionally, the notification rules may include: allowing presence information to be notified when a receipt number of times of a watcher subscribing the presence information does not exceed a limit on number of times and/or a receipt frequency of the watcher does not exceed a transfer frequency.

Optionally, the notification rules may include: determining whether to publish the presence information in accordance with a status of the presentity.

Optionally, the content-related processing rules may include a maximum subscription times, and the presence information is allowed for subscription when the number of subscription is less than the maximum subscription times.

Optionally, the content-related processing rules set by the presentity may include: allowing a watcher to receive presence information when a receipt frequency and/or a receipt period of the watcher is within a scope.

Another embodiment of the present invention provides a system for notifying presence information which may include a presentity client or presentity application server, a presence server, a watcher client or watcher application server, and a presence XDMS (XML Document Management System). The presence server is adapted, upon receiving presence information sent from the presentity client or presentity application server, to transfer to the watcher client or watcher application server the presence information that is conformable to notification rules in the presence server or the presence XDMS by the presentity and content-related processing rules in the presence server or the presence XDMS by the presentity.

Optionally, the presence server may include a publication and notification processing component and notification rules processing component, and the publication and notification processing component is adapted to determine a watcher for receiving the presence information in accordance with the subscription relationship, to send to the notification rules processing component a query whether a presentity publishing the presence information has set notification rules, and to process the presence information in accordance with the content-related processing rules and a response returned from the notification rules processing component; and the notification rules processing component is adapted to, upon receiving the query sent from the publication and notification processing component whether the presentity publishing the presence information has set notification rules, determine whether the presentity has set the notification rules, and if yes, determine whether the notification rules are met in accordance and send the response to the publication and notification processing component.

Optionally, the notification rules may include: allowing presence information to be notified when notification time of the presence information is within a validity term and/or a prescribed publication period.

Optionally, the notification rules may include: allowing presence information to be notified when a receipt number of times of a watcher subscribing the presence information does not exceed a limit on number of times and/or a receipt frequency of the watcher does not exceed a transfer frequency.

Optionally, the notification rules may include: determining whether to publish the presence information in accordance with a status of the presentity.

Optionally, the content-related processing rules may include a maximum subscription times, and the presence information is allowed for subscription when the number of subscription is less than the maximum subscription times.

Optionally, the content-related processing rules may include: allowing a watcher to receive presence information when a receipt frequency and/or a receipt period of the watcher is within a scope.

Another embodiment of the present invention provides a presence server including a publication and notification processing component and a notification rules processing component. The publication and notification processing component is adapted to determine a watcher for receiving the presence information in accordance with the subscription relationship, to send to the notification rules processing component a query whether a presentity publishing the presence information has set notification rules, and to process the presence information in accordance with the content-related processing rules and a response returned from the notification rules processing component; and the notification rules processing component is adapted, upon receiving the query sent from the publication and notification processing component whether the presentity publishing the presence information has set notification rules, to determine whether the presentity has set the notification rules, and if yes, whether the notification rules are met in accordance with the notification rules, and to send the response to the publication and notification processing component.

Optionally, the notification rules may include: allowing presence information to be notified when notification time of the presence information is within a validity term and/or a prescribed publication period.

Optionally, the notification rules may include: allowing presence information to be notified when a receipt number of times of a watcher subscribing the presence information does not exceed a limit on number of times and/or a receipt frequency of the watcher does not exceed a transfer frequency.

Optionally, the notification rules may include: determining whether to publish the presence information in accordance with a status of the presentity.

Optionally, the content-related processing rules may include a maximum subscription times, and the presence information is allowed for subscription when the number of subscription is less than the maximum subscription times.

Optionally, the content-related processing rules may include: allowing a watcher to receive presence information when a receipt frequency and/or a receipt period of the watcher is within a set scope.

A further embodiment of the present invention provides a presence XDMS applicable to a system for notifying presence information, and the presence XDMS may include a reading unit and a storage unit. The reading unit is adapted to forward received external input data to the storage unit, and when receiving a data retrieval signal sent from an external component, read corresponding data in the storage unit in accordance with type of the signal, and output the data to the external component that has sent the data retrieval signal, the external input data comprises a notification rules; and the storage unit is adapted to receive and store the data input from the reading unit.

In the embodiments of the present invention, the resources of a presence server may be utilized more appropriately and the publication of presence information is enabled to be more rationalized and humanized. A user may determine whether to receive the published information and what published information to receive according to the actual requirement.

### BRIEF DESCRIPTIONS OF THE DRAWINGS

FIG. 1 is a structural diagram of a system for notifying presence information in the prior art;

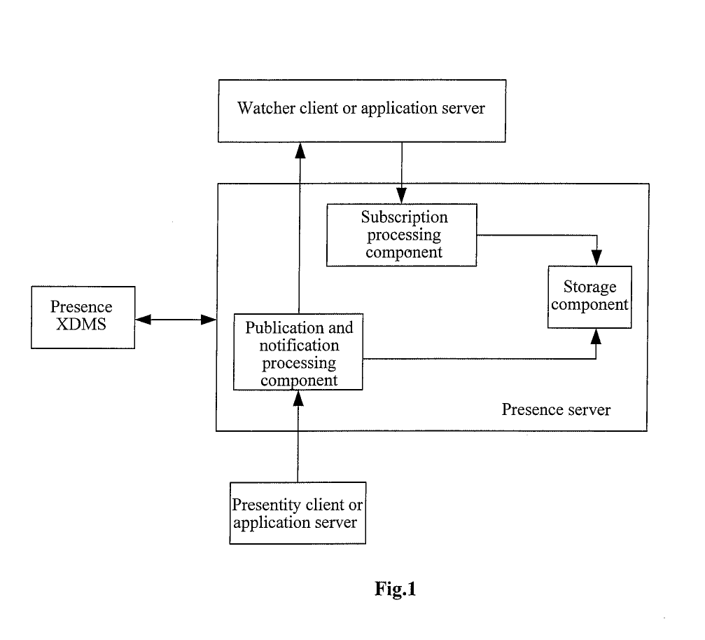

FIG. 2 is a structural diagram of a publication and notification processing component in the prior art;

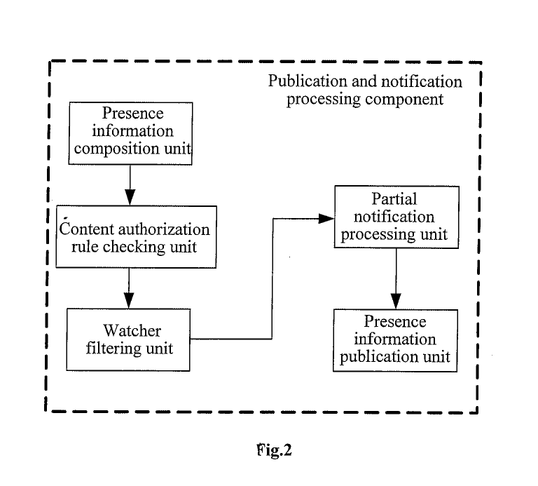

FIG. 3 is a flow chart of a method for notifying presence information in the prior art;

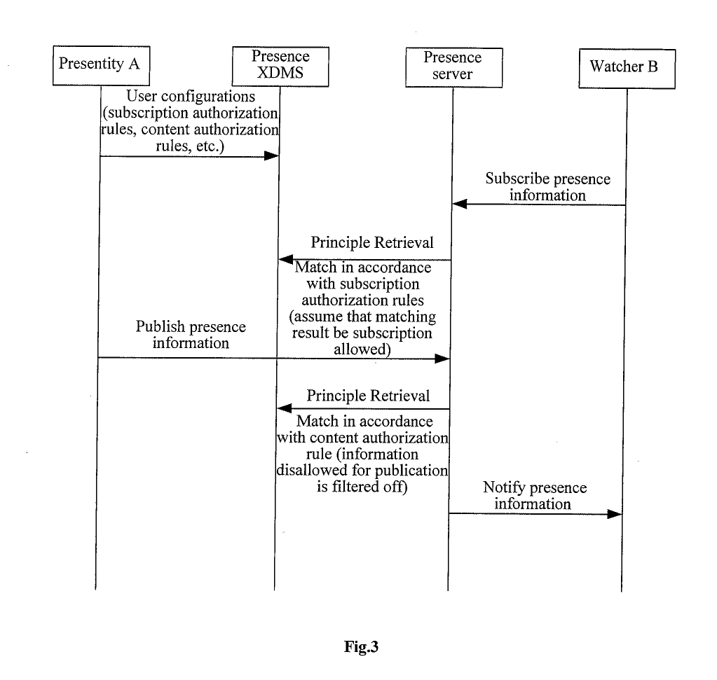

FIG. 4 is a structural diagram of a system for notifying presence information according to an embodiment of the present invention;

FIG. 5 is a flow chart of a method for notifying and publishing according to an embodiment of the present invention;

FIG. 6 is a structural diagram of a publication and notification processing component according to an embodiment of the present invention.

### DETAILED DESCRIPTION OF THE INVENTION

The embodiments of the present invention will be further described with reference to the drawings.

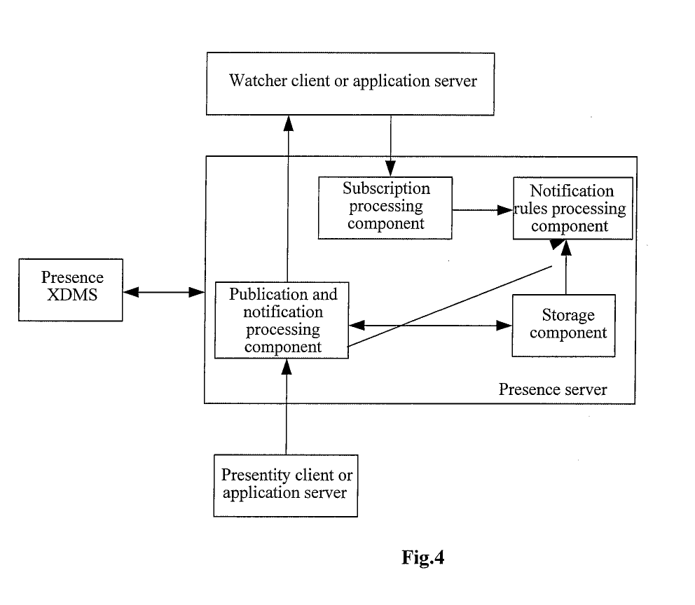

Referring to FIG. 4, similar to the presence system in the prior art, an improved system for notifying presence information includes a presentity client or presentity application server, a presence server, a watcher client or watcher application and a presence XDMS. The difference lies in that a notification rules processing component is added in the presence server. In other words, the presence server includes a subscription processing component, a storage component, a publication and notification processing component and a notification rules processing component.

The subscription processing component receives a SUBSCRIBE message from the watcher client or watcher application server, retrieves a subscription authorization rules set by the corresponding presentity in the presence XDMS, and determines the subscription result for the watcher client or watcher application server in accordance with the subscription authorization rules, and if the subscription is allowed, stores the subscription relationship in the storage component.

The storage component stores the information on subscription relationship, publish content, etc.

The publication and notification processing component receives a publish request sent from the presentity client or presentity application server, and gets a certain subscriber (a watcher) from the storage component, and retrieves content-related processing rules and notification rules set by the presentity and the watcher from the presence XDMS, then sends a query to the notification rules processing component, processes the presence information in accordance with the content-related processing rules set by the presentity and the watcher and a response returned from the notification rules processing component, and notifies the watcher client or watcher application server of the processed (combined, composed, content-filtered, etc.) presence information.

The notification rules processing component receives the query sent from the publication and notification processing component whether the presentity has set a notification rules, then determines whether there is any notification rules set by the presentity, and if there is, determines in accordance with the notification rules whether a notification condition is met, and then returns a response to the publication and notification processing component.

The subscription processing component and the storage component in the presence server may be identical to those in the prior art, and therefore will not be described here.

The presence XDMS is adapted to store authorization rules (e.g. subscription authorization rules, content authorization rules, etc.) set by the presentity, and is also adapted to store notification rules set by the presentity. The presence XDMS includes a reading unit and a storage unit.

The reading unit is adapted to forward received external input data to the storage unit, and upon receiving a data retrieval signal sent from an external component, reads corresponding data in the storage unit in accordance with the type of this signal, and outputs the corresponding data to the external component that sends the data retrieval signal. The external input data includes the notification rules.

The storage unit is adapted to receive and store the data input from the reading unit.

In the system for presenting information, the presentity client or presentity application server and the watcher client or watcher application server are identical to those in the prior art, and therefore will not be described here.

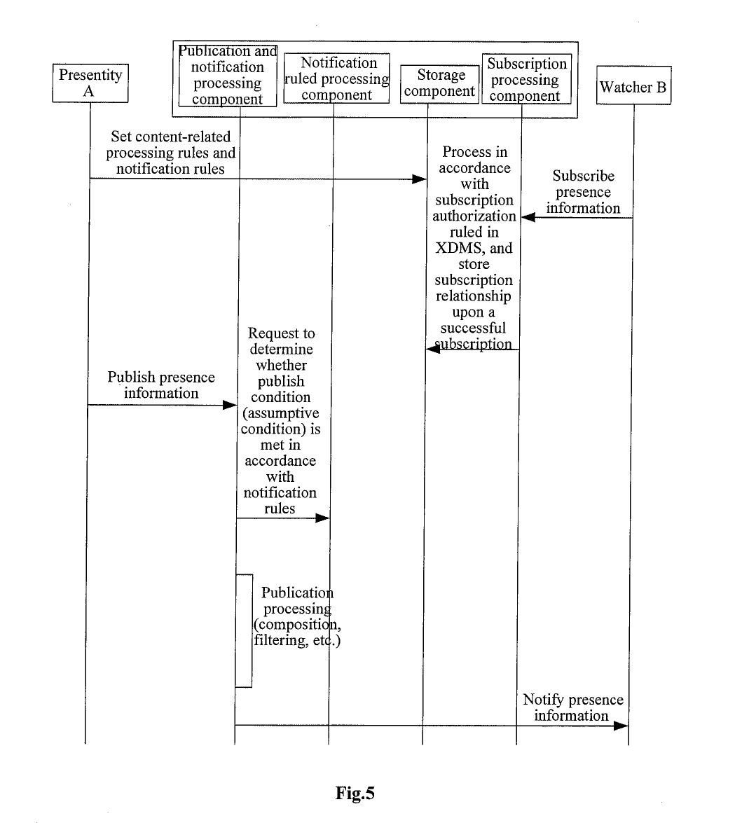

Referring to FIG. 5, a flow of a method for notifying presence information will be described hereinafter. Presentity A represents a presentity client or presentity application server, and watcher B represents a watcher client or watcher application server:

1) The presentity A sets content-related processing rules and notification rules;

2) The watcher B sends a subscription request to a presence server, to subscribe the presence information of the presentity A;

3) The presence server processes in accordance with subscription authorization rules stored in a presence XDMS. If the subscription authorization is not passed, the subscription fails, otherwise, the presence server stores the subscription relationship;

The above content-related processing rules may include subscription authorization rules. For example, the presence information will not be allowed for publication unless the number of times that the presence information has been published is below a maximum number of times. The content-related processing rules may also include rules that the watcher is allowed to receive the presence information only when a receipt frequency or receipt period of the watcher is within a scope;

4) The presentity A publishes presence information to the presence server;

5) The presence server determines the watcher B in accordance with the subscription relationship, and determines whether the presentity A has set notification rules, and if there is notification rules, determines whether the watcher B meets the notification rules and continues to execute step 6), or if there is no notification rules, proceeds in accordance with the presence method in the prior art;

In this step, the process that the presence server determines whether the watcher B meets the notification rules includes:

(a) determining whether it is within the validity period, such as Oct. 1, 2005˜Sep. 1, 2005; if it is not within the validity period, blocking the notification of presence information to the subscriber, otherwise, determining in accordance with other rules;

(b) determining whether it is within a prescribed notification period, such as 8:00˜18:00 of each day; if it is not within the prescribed notification period, blocking the notification of presence information to the subscriber, otherwise, determining in accordance with other rules. For example, the presentity has set a prescribed notification period such as 8:00˜18:00 of each day, if the time the presence server receives publish information is 9:00, it meets the requirement of the rules;

(c) determining whether the number of times that the watcher B has received information exceeds an upper limit; if it exceeds the upper limit, blocking the notification of presence information to the subscriber, otherwise, determining in accordance with other rules. The presentity A may set a limit to the number of times that the watcher B receives information. For example, the total number of times is 1000 with 10 times for each day, then a counter may be set for the total number and the number for each day. Then, the counter for the total number is increased by one each time information is received, and the counter for each day counts from zero every day, and is increased by one each time information is received. Prior to sending a notification, it may be determined whether the current total number of times exceeds 1000 and whether the number of times for the current day exceeds 10, and if information transfer is allowed, both the total number and the number for the current day are increased by one. On the next day, the counter for each day is reset to zero; but the counter for the total number is not reset to zero;

(d) determining whether the receipt frequency that the watcher B receives information is above a set transfer frequency; if the receipt frequency is above the transfer frequency, blocking the notification of presence information to the subscriber, otherwise, determining in accordance with other rules. There may be two ways to set the transfer frequency: (1) once every ten minutes. For example, if starting from 8:00, between 8:00˜8:10, the presence server may choose to either process the most recently published information and notify the watcher of the processed information at the time of 8:10, or combine the presence information published several times within these ten minutes and publish the combined information to the watcher; (2) no more than ten pieces of information within one minute; in this case, once the publish information is received, the presence server processes the information and notifies the watcher of the processed information, and counts; the information beyond the limit of ten pieces will be dropped; The above notification rules for the presence server to determine whether the watcher B meets the notification rules may include one or more rules, and further the order of determinations may be set arbitrarily. When all the rules have been referred to, the process proceeds to step 6);

6) When the watcher B meets the notification rules, the presence server performs processing for publication (including information composition, content authorization, event notification filtering, and the like, the content authorization an the event notification filtering are optional), and publishes the presence information to the watcher B. If the watcher B does not meet the notification rules, the presence server aborts the notification of presence information to the watcher B.

In one embodiment according to the present invention, the notification rules may be set by a user client in the presence XDMS or in the presence server. The notification rules processing component in the presence server may retrieve the rules from the presence XDMS or the presence server for further processing. The notification rules may be modified and set by the presentity client through the XCAP protocol in the XDMS, or may be modified and set in any other ways. For example, the presence server may provide the presentity with a WEB interface to view the notification rules set by the presentity, and allow the presentity to initially set or modify its notification rules via the WEB interface.

It shall be noted that in addition to the rules content mentioned in the above embodiments, the notification rules may also include other rules contents, such as determining whether to publish presence information in accordance with the status of the presentity.

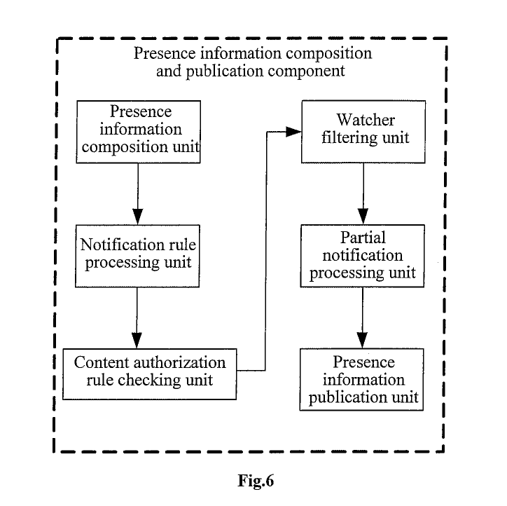

Although in the above embodiment the notification rules processing component is located in the presence server and separated from the publication and notification processing component, the notification rules processing component with the same functions may be located in the publication and notification processing component in another embodiment. The structural diagram of this publication and notification processing component is as shown in FIG. 6, the method for notifying presence information is similar to the above embodiment and the descriptions thereof will not be repeated here.

In an alternative embodiment, the watcher B may subscribe the presence information directly from the presentity A without setting subscription authorization rules. It may be determined flexibly where to store the subscription authorization rules, the subscription relationship, etc. For example, they may be stored in the presence server or in the presence XDMS.

It shall also be noted that the content-related processing rules and the notification rules are set and stored in the presence XDMS, and in another embodiment, they may be set and stored in the presence server. Moreover, the notification rules may also be included in the content-related processing rules.

In the present embodiment, both the watcher and the presentity may be presentity client or application server, and the application server may include a game server or a server with similar functions, and may also include an instance message server (e.g. an ICQ/MSN server) etc.

It shall further be noted that in the above flow, it may be determined that the notification rules are met if there is no limiting condition. Thus, there is no limit to the processing order of the procedure of determining the notification rules and publication (involving the processes of the presence information composition component, the content authorization rules checking component, the watcher filtering component, the partial notification processing component and the presence information publish component). The objects of the present invention may be attained no matter how the order would be. The various conditions may be stored and processed in the form of database.

It shall be noted that those skilled in the art may easily implement each operational step and the setting of each rules or policy concerned in the embodiments of the present invention by means of programming techniques in the prior art.

Some application embodiments will be described hereinafter.

1. A traffic information service may provide presence information on road conditions for all weather, 24 hours a day, but with a charge. The service may be free for a new user with some limiting conditions. For example:

(1) The presence information may be received for free for 1000 times.

(2) The period for free receipt may be limited to 8:00˜12:00 each morning.

(3) The service may be tried out twice for free. In other words, a user may subscribe and try the service again when a limiting condition for free usage expires, but has to pay when the limiting condition for free usage expires again.

A new user with a free subscription may receive the presence information during only a limited period each morning, and the service will become invalid after 1000 times of receipt. The new user has to subscribe again for another free tryout. However, the service can no longer be tried out if it becomes invalid again unless the user pays.

In this embodiment, the traffic information service server is a presentity, and the user is a watcher.

The specific implementation of this embodiment will be described hereinafter.

The notification rules in this embodiment may be included in the content authorization rules, and in another embodiment, may be a rule file newly created instead of being included in the content authorization rules.

The subscription authorization rules (with a principle of precise matching, i.e., a general field will not be matched if a specific user has been matched):

| | | Limit on subscription |
|---|---|---|
| Watcher ID | Result | number of times |
| zhangsan@future.com | BLOCK | 2 |
| *@163.com | ALLOW | 2 |

the content authorization rules may be:

| | Information on | number of times | |
|---|---|---|---|
| Watcher ID | road conditions | for receipt | Receipt period |
| *@163.com | ALLOW | 1000 | 8:00˜12:00 |

When the watcher ID has a field “@163.com”, the watcher may be allowed for subscription twice (the limit on subscription number of times is decreased by one automatically when the subscription succeeds once, and the subscription is disallowed when the limit on subscription number of times reaches zero). If there is no limiting condition set on the limit on subscription number of times, the default number of times of the presence server may be one, or alternatively, it may be default that there is no limit on the subscription number of times, and the default number of times may be set by the presence server. Here, the subscription generally refers to an initial subscription of a watcher, not including the number of times for refreshing the subscription. If a subscription without timely refresh has expired, when re-subscribing, the subscription number of times is increased by one. In fact, it may be sufficient to limit the amount of information obtained by the watcher through only the condition of the receipt number of times, in that the watcher may have to re-subscribe due to various reasons, such as instability of a network or client, powering on or off, etc., and thus, the limit on the subscription number of times will not be appropriate. For example, when the traffic information service publishes information at the time of 9:00 am., the ID “@163.com” may be matched, and the result may be allowed for subscribing information on road conditions, and the notification rules may specify that the watcher with a matched ID may be allowed to receive the information for 1000 times, and the receipt period may be 8:00˜12:00 each day. The presence server determines whether the number of times the watcher has received the information is no more than 1000 and whether the time of 9:00 is within the scope of 8:00˜12:00. If that number of times is no more than 1000, and that time is within the that scope, the result of the notification rules may be ALLOW, and the presence server will send the information on road conditions to the watcher, and the number of times that the watcher has received the information will be increased by one.

The above notification rules may be described as follows in the XML format.

<conditions>

<identity> <domain domain=“163.com”/> </identity>
<period>

<from>T08:00:00.000+08:00</from>
<until>T12:00:00.000+08:00</until>

</period>
<subscribe-counts limit=“2”>1</subscribe-counts>
<receive-counts limit=“1000”>88</receive-counts>

</conditions>

The limit on period is designated in the element <period> including a starting time <from> and an ending time <until> of the period, and the format of time includes year, month, date, minute, second, time zone, etc. If the presence server detects only the absence of year information, it indicates that a yearly period has been set. If the presence server detects the absence of year and month information, it indicates that a monthly period has been set. If the presence server detects the absence of year, month and date information, it indicates that a dayly period has been set, and so on. The starting and ending times may also be used as attributes of the element <period>. The limit on subscription number of times is designated in the element <subscribe-counts>, in which the limit attribute indicates an allowed subscription number of times, and the value of the element <subscribe-counts> indicates the number of times that the subscription has been performed. The same may apply to the element <receive-counts> which indicates the limit on receipt number of times.

When the actual subscription number of times and receipt number of times change, the presence server will update the values of the elements <subscribe-counts> and <receive-counts>. If the actual subscription number of times and receipt number of times are recorded in an authorization rules file, the presence server will further modify that authorization rules file stored in the XDMS in synchronization with the change of the values of the elements. Preferably, the actual subscription number of times and receipt number of times may be stored separately from the limits on number of times. In other words, the limit on subscription number of times and the limit on receipt number of times may be stored in the authorization rules file, which may be retrieved by the presence server from the presence XDMS, while the actual subscription number of times and receipt number of times may be stored locally into the presence server instead of the presence XDMS. The presence server may create for each watcher user a record of subscription/receipt number of times, and update the record when the number of times changes. Thus, the authorization rules file will not have to store a large number of records resulted from the different actual subscription/receipt number of times of respective watchers, and it will be unnecessary to frequently synchronize the authorization rules buffered in the presence server with the authorization rules file stored in the presence XDMS. As in the following authorization rules file, the presentity may set the same limit on number of times for all watchers or the watchers within a certain domain:

<conditions>

<identity> <domain domain=“163.com”/> </identity>
<subscribe-counts limit=“2”/>
<receive-counts limit=“1000”/>

</conditions>

The presence server records the actual numbers of times for different watchers, for example:

| | | subscription | receipt |
|---|---|---|---|
| | | number of | number of |
| Watcher ID | Presentity ID | times | times |
| User1@163.com | traffic@service.com | 1 | 88 |
| User2@163.com | trafFic@service.com | 2 | 101 |

Upon detecting the actual receipt number of times of a watcher with a matched ID exceeds the limit on receipt number of times designated in the authorization rules, the presence server blocks the transfer of the corresponding presence information.

2. User A may wish to publish his own presence information to his collogues during working period (8:00˜18:30 each day), and not to publish his presence information to his collogues during other periods.

The user may set a limit, with respect to *@163.com, to the period that a watcher obtains the presence information, while setting no limit to the receipt number of times and the subscription number of times.

The subscription authorization rules (with the principle of precise matching, i.e., a general field will not be matched if a specific user has been matched):

| Watcher ID | Result | Priority |
|---|---|---|
| zhangsan@163.com | BLOCK | 1 |
| *@163.com | ALLOW | 2 |

The content authorization rules:

| | | | A number of | |
|---|---|---|---|---|
| | Location | Game | times for | Receipt |
| Watcher ID | information | information | receipt | period |
| *@163.com | ALLOW | BLOCK | No limit | 8:00˜18:30 |

When the ID of a watcher has the field “@163.com” which is not “zhangsan@163.com”, the watcher may be allowed for subscription. When user A publishes presence information at the time of 9:00, the presence server determines that there is no limit on receipt number of times in the notification rules, and the publication period is 8:00˜18:30, the result is ALLOW, and the content is ALLOW for receipt of location information, but is BLOCK for receipt of game information. The presence server distributes the location information to all watchers with the ID “@163.com” except “zhangsan@163.com”, and thereafter the receipt numbers of times of respective watchers will be increased by one respectively.

3. A presentity may wish not to publish his presence information to a watcher when the presentity is in a special status. For example, a boss has subscribed the presence information related to the location and status of an employee. When playing a game, the presentity (the employee) changes his presence status to “In Game”, and he has set in advance not to send the presence information on the location and the status “In Game” to the boss when the presentity is in such a status. As a result, though the presentity transmits the information to the presence server, the presence server will not send the presence information to the subscriber, i.e. the boss, in accordance with the setting of the presentity.

Notification Rules:

| | | Watchers allowed for | Watchers disallowed for |
|---|---|---|---|
| Status or location | Action | notification | notification |
| In Game | Limit the group to be notified | *@game.com | boss@163.com |
| | of presence information | | |
| At Work | Do not send work-related | *@163.com | *@game.com |
| | information to a game team | | |
| In Travel | Do not notify company colleagues | zhangsan@future.com | *@163.com |
| | of location information | lisi@sina.com | |

As obvious from the above notification rules, when the employee (presentity) is in the status “In Game”, the presence information is allowed to be notified to *@game.com, but disallowed to be notified to boss@163.com. When the employee (presentity) is in the status “At Work”, the presence information is allowed to be notified to *@163.com, but disallowed to be notified to *@game.com. When the employee (presentity) is in the status “In Travel”, the presence information is allowed to be notified to zhangsan@future.com and lisi@sina.com, but disallowed to be notified to *@163.com.

In a preferred embodiment according to the present invention, the notification rules may include determining the receipt statuses of all watchers and performing corresponding processes as follows: the notification rules processing component determines the receipt statuses of all watchers. For example, in accordance with whether a watcher is online. If each of the watchers is in a status incapable of receiving the presence information, the publication and notification processing component in the presence server will notify the presence client or application server not to publish presence information during this period. When there is a watcher in a status capable of information receipt, the presence server may notify the presentity to proceed with publication.

While the embodiments in which a presentity sets notification rules have been described as above, a watcher may also set receipt rules. The receipt rules may be set in the presence XDMS or the presence server, or may be set through a SUBSCRIBE message upon subscription. The receipt rules may be stored in the presence server or the presence XDMS. The watcher may set validity term for subscription, subscription period, receipt number of times and a receipt frequency in the receipt rules. A corresponding receipt rules processing component may be employed to determine in the same way as the notification rules whether it is within the validity term for subscription, the subscription period, or the receipt number of times, and to determine whether the condition is met in accordance with the receipt frequency. Moreover, the presence server may process in accordance with the receipt frequency, the receipt period and the receipt status, and then notify the presentity client to control the rate/frequency and the period for publication information. In the system, the notification rules set by the presentity may be processed first, and then the receipt rules set by the watcher may be processed. Subsequently, the publication and notification processing component processes publish information in accordance with the content related processing rules set by the presentity and the watcher, and transfers the processed information to the watcher. The processing flow and means are similar to those used to process the rules set by the presentity as described above, the descriptions thereof will not be repeated here. Those skilled in the art may implement the solutions provided according the embodiments of the present invention by means of various technologies in the prior art without any inventive effort.

While some preferred embodiments of the present invention have been described above, the scope of the present invention shall not be limited thereto. Those skilled in the art may make various changes and modifications without departing the scope of the present invention. It is thus intended that all these changes and modifications shall fall within the scope of the present invention as defined in the appended claims.

1. A method for notifying presence information, comprising:
transferring, by a presence server, to either one of a watcher client or watcher application server the presence information that is conformable to notification rules set by a presentity as well as content related processing rules set by a watcher and the presentity, when receiving the presence information sent from either one of a presentity client or presentity application server.

2. The method according to claim 1, wherein the notification rules comprise: allowing presence information to be notified when notification time of the presence information is within at least one of a validity term and a prescribed publication period.

3. The method according to claim 1, wherein the notification rules comprise: allowing presence information to be notified in at least one of the following two cases: when a receipt number of times of a watcher subscribing the presence information does not exceed a set limit on number of times and when a receipt frequency of the watcher does not exceed a set transfer frequency.

4. The method according to claim 1, wherein the notification rules comprise: determining whether to publish the presence information in accordance with a status of the presentity.

5. The method according to claim 1, wherein the content related processing rules comprise a maximum subscription times, and the presence information is allowed for subscription when times for subscription is less than the maximum subscription times.

6. The method according to claim 1, wherein the content related processing rules set by the presentity comprises: allowing a watcher to receive presence information when a receipt frequency and/or a receipt period of the watcher is within a set scope.

7. A system for notifying presence information, comprising either one of a presentity client or presentity application server, a presence server, either one of a watcher client or watcher application server, and a presence XDMS (XML Document Management System), wherein:
the presence server is adapted, when receiving presence information sent from the presentity client or presentity application server, to transfer to the watcher client or watcher application server the presence information conformable to notification rules set in the presence server or the presence XDMS by the presentity and a content related processing rules set in the presence server or the presence XDMS by the presentity.

8. The system according to claim 7, wherein the presence server comprises a publication and notification processing component and a notification rules processing component, wherein:
the publication and notification processing component is adapted to determine a watcher for receiving the presence information in accordance with a subscription relationship contained in the content related processing rules, to send to the notification rules processing component a query whether a presentity publishing the presence information has set the notification rules, and to process the presence information in accordance with the content related processing rules and a response returned from the notification rules processing component; and
the notification rules processing component is adapted to, upon receiving the query sent from the publication and notification processing component whether the presentity publishing the presence information has set the notification rules, determine whether the presentity has set the notification rules, and if yes, determine whether the notification rules are met, and send the response to the publication and notification processing component.

9. The system according to claim 7, wherein the notification rules comprise: allowing presence information to be notified when notification time of the presence information is within a validity term and/or a prescribed publication period.

10. The system according to claim 7, wherein the notification rules comprise: allowing presence information to be notified when a receipt number of times of a watcher subscribing the presence information does not exceed a limit on number of times and/or a receipt frequency of the watcher does not exceed a transfer frequency.

11. The system according to claim 7, wherein the notification rules comprise: determining whether to publish the presence information in accordance with a status of the presentity.

12. The system according to claim 7, wherein the content related processing rules comprise subscription authorization rules comprising maximum subscription times, and the presence information is allowed for subscription when number of subscription is less than the allowable maximum subscription times.

13. The system according to claim 7, wherein the content related processing rules comprise: allowing a watcher to receive presence information when a receipt frequency and/or a receipt period of the watcher is within a set scope.

14. A presence server comprising a publication and notification processing component and a notification rules processing component, wherein:
the publication and notification processing component is adapted to determine a watcher for receiving the presence information in accordance with a subscription relationship, to send to the notification rules processing component a query whether a presentity publishing the presence information has set notification rules, and to process the presence information in accordance with the content related processing rules and a response returned from the notification rules processing component; and
the notification rules processing component is adapted, upon receiving the query sent from the publication and notification processing component whether the presentity publishing the presence information has set notification rules, to determine whether the presentity has set the notification rules, and if yes, determine whether the notification rules are met in accordance with the notification rules, and to send the response to the publication and notification processing component.

15. The presence server according to claim 14, wherein the notification rules comprise: allowing presence information to be notified when notification time of the presence information is within a validity term and/or a prescribed publication period.

16. The presence server according to claim 14, wherein the notification rules comprise: allowing presence information to be notified when a receipt number of times of a watcher subscribing the presence information does not exceed a set limit on number of times and/or a receipt frequency of the watcher does not exceed a set transfer frequency.

17. The presence server according to claim 14, wherein the notification rules comprise: determining whether to publish the presence information in accordance with a status of the presentity.

18. The presence server according to claim 14, wherein the content related processing rules comprise maximum subscription times, and the presence information is allowed for subscription when times for subscription is less than the allowable maximum subscription times.

19. The presence server according to claim 14, wherein the content related processing rules comprise: allowing a watcher to receive presence information when a receipt frequency and/or a receipt period of the watcher is within a set scope.

20. A presence XML Document Management System applicable to a system for notifying presence information, comprising a reading unit and a storage unit, wherein:
the reading unit is adapted to forward received external input data to the storage unit, and when receiving a data retrieval signal sent from an external component, read corresponding data in the storage unit in accordance with type of the signal, and output the data to the external component that has sent the data retrieval signal, the external input data comprising a notification rules; and
the storage unit is adapted to receive and store the data input from the reading unit.

21. The method according to claim 1, wherein the notification rules are set by either one of the presentity or the watcher.

22. The method according to claim 1, wherein the notification rules comprise: determining whether to publish the presence information in accordance with status of all watchers.

23. The presence server according to claim 14, wherein the notification rules comprise: determining whether to publish the presence information in accordance with status of all watchers.
